(19) United States
(12) Patent Application Publication
(10) Pub. No.: US 2009/0036269 A1
(43) Pub. Date: Feb. 5, 2009

(54) Limp home mode driving method for hybrid electric vehicle and engine clutch control hydraulic system for limp home driving

(75) Inventor: Yeon Ho Kim, Gyeonggi-do (KR)

Correspondence Address: Edwards Angell Palmer & Dodge LLP, P.O. Box 55874, Boston, MA, 02205, US

(73) Assignees: Hyundai Motor Company, Seoul (KR); Kia Motors Corporation, Seoul (KR)

(21) Appl. No.: 11/999,745

(22) Filed: Dec. 7, 2007

(30) Foreign Application Priority Data
Aug. 3, 2007 (KR) 10-2007-0077973

(51) Int. Cl. B60W 10/02

(52) U.S. Cl. 477/174

(57) ABSTRACT

The present invention provides a limp home mode driving method for a hybrid electric vehicle and an engine clutch control hydraulic system for driving in the limp home mode. At a hydraulic circuit for supplying hydraulic fluid to an engine clutch mounted between an engine and a driving motor, an engine clutch control hydraulic system is installed and includes an engine clutch control solenoid valve which controls the supply of hydraulic fluid to the engine clutch. As the engine clutch control solenoid valve, a normal high type solenoid valve is used which always keeps an internal passage open for engine clutch hydraulic fluid so that the engine clutch control pressure is at its maximum when power is cut off. Thus, when engine clutch control solenoid valve power goes off due to a failure, hydraulic fluid is supplied to the engine clutch through the internal passage and the engine clutch is closed. Thus, the engine is connected to the driving motor, and the vehicle limp home driving by the drive power of the engine can be accomplished by driving the engine.

### CROSS-REFERENCE TO RELATED APPLICATION

This application claims priority under 35 U.S.C. §119(a) from Korean Patent Application No. 10-2007-0077973, filed on Aug. 3, 2007, the entire contents of which are incorporated herein by reference.

### BACKGROUND

(a) Technical Field

The present invention relates to a limp home drive method for a hybrid electric vehicle and an engine clutch control hydraulic system for limp home driving. More particularly, the present invention relates to a limp home drive method for effecting limp home driving by drive power of an engine in the event of engine clutch controller failure or engine clutch control solenoid valve failure in a hybrid electric vehicle, and an engine clutch control hydraulic system for implementing such limp home driving.

(b) Background Art

A hybrid vehicle, in a broad sense, means a vehicle driven by combining at least two different types of power source. In most cases, the hybrid vehicle is powered by an engine that runs on fuel and a motor that runs on an electric battery. Such a hybrid vehicle is referred to as a hybrid electric vehicle (HEV).

To meet the demands of today's society for improved fuel efficiency and the development of a more environmentally friendly product, research into hybrid electric vehicles is being actively conducted.

Hybrid electric vehicles can have various power transfer structures using an engine and a motor as power sources. Most vehicles that have been researched up to present adopt one of a parallel type and a serial type.

Here, the serial type in which the engine and the motor are arranged in series has the advantages of a simpler structure and simpler control logic than the parallel type. In contrast, since it stores mechanical energy from the engine in a battery used to power the motor and drive the vehicle, it has the disadvantage of poor efficiency in converting energy. On the other hand, the parallel type has the disadvantages of a more complicated structure and more complicated control logic than the serial type. By contrast, since it can use the engine's mechanical energy and the battery's electrical energy simultaneously, it has the advantage of efficiency in using energy.

FIG. 1 is a schematic diagram of a drive system and a power train structure of a hybrid electric vehicle employing an engine clutch. An engine 10 and a driving motor 20 are provided as power sources, a torsion damper 11 and an engine clutch 12 are interposed between the engine 10 and the driving motor 20, and the output end of the driving motor 20 is connected to an automatic transmission 30.

In the illustrated hybrid electric vehicle, the driving motor 20 which is efficient at low RPM is used for initial acceleration. When the vehicle reaches a predetermined speed, a generator that has the function of a starter motor, i.e., an integrated starter and generator (ISG) 40, starts the engine 10, and the outputs of the engine 10 and the driving motor 20 are used simultaneously.

Rotational power from the engine 10 and the driving motor 20 is adjusted to an appropriate speed in the automatic transmission, transferred to a drive shaft 50, and finally transferred to a drive wheel 51.

In the power train structure of the hybrid electric vehicle, the engine clutch 12 is disposed between the engine 10 and the driving motor 20 to control the connection of the rotational power of the engine. According to its state of being open or closed, the engine clutch 12 makes it possible to choose and switch between an electric vehicle (EV) mode, which uses only the rotational power of the driving motor 20, and a hybrid electric vehicle (HEV) mode, which simultaneously uses the rotational power of the engine 10 and the driving motor 20 together.

Upon initial acceleration and at low speeds, the EV mode is chosen and the engine clutch is opened such that the engine 10 is disconnected and the vehicle is powered solely by the driving motor 20. In particular, upon initial acceleration of the vehicle, since the efficiency of the engine 10 is lower than the efficiency of the driving motor 20, using the more efficient driving motor 20 improves fuel efficiency.

Also, under specified driving conditions, such as when the vehicle is driven beyond a predetermined speed, the HEV mode in which the vehicle is powered by both the engine 10 and the driving motor 20 together is chosen by closing the engine clutch 12. This connects the engine 10 with the driving motor 20 such that the rotational power of the engine 10 and the driving motor 20 together are transferred to the drive shaft 50 and the vehicle is driven by the combined rotational power of the engine 10 and the drive motor 20.

In this manner, the choice of the EV mode or the HEV mode is accomplished by controlling the operation of the engine clutch 12. When switching from the EV mode to the HEV mode, the engine clutch 12 is closed to connect the engine's rotational power. Such operation of the engine clutch 12 is controlled by a hydraulic system.

FIG. 2 is a hydraulic circuit diagram showing a conventional engine clutch control hydraulic system in a hybrid electric vehicle. It shows the initial operation state of an engine clutch control solenoid valve 62a when power is turned off.

As shown in the figure, the engine clutch control hydraulic system includes a hydraulic circuit 61 for supplying hydraulic fluid to the engine clutch 12, and an engine clutch control solenoid valve 62a installed along the hydraulic circuit 61 and controlling the supply of hydraulic fluid to the engine clutch 12.

Here, the engine clutch control solenoid valve 62a has a structure in which the supply of hydraulic fluid to the engine clutch 12 is controlled by opening/closing of an internal passage 65 according to the position of a spring-supported spool 64.

In the engine clutch control solenoid valve 62a, a valve control pressure, generated by receiving separate hydraulic fluid for controlling the clutch valve (hereinafter referred to as valve control hydraulic fluid) via a hydraulic line 61a, is applied directly to the spool 64 inside the valve and thereby the spool 64 overcomes the spring force and operates. As a result, the internal passage 65 supplying hydraulic fluid to the engine clutch 12 is opened and thus the engine clutch 12 is supplied with hydraulic fluid through the hydraulic line 61c.

In the engine clutch control solenoid valve 62a, after the valve control hydraulic fluid generating the valve control pressure passes through the internal passage 65 in the valve, it is supplied back into the valve via a separate hydraulic line 61 b and acts on the spool 64 inside the valve to operate the spool 64. The internal passage 65 for supplying hydraulic fluid to the engine clutch 12 is opened by the operation of the spool 64.

However, such a conventional engine clutch control hydraulic system has the following problems.

In the event of engine clutch controller (HCU or TCU) failure or engine clutch control solenoid valve failure, it is impossible for the vehicle to drive in a limp home mode.

The reason for this is that the engine clutch control solenoid valve 62a has a normal low (NL) type valve structure which maintains a blocked state of the internal passage 65 of the valve control hydraulic fluid, as shown in FIG. 2.

That is, in the NL type valve structure, when there is a failure of the engine clutch controller or the valve itself, in a state where the operational power is not supplied, the internal passage 65 of the valve control hydraulic fluid is maintained in a blocked state. In a state where the valve control pressure for controlling the operation of the spool 64 is blocked, the internal passage 65 for supplying hydraulic fluid to the engine clutch stays blocked and thus the valve control pressure and the pressure of hydraulic fluid supplied to the engine clutch are both “0”.

Accordingly, when the engine clutch controller (for instance, HCU, TCU), not depicted, fails and the operational power to the engine clutch control solenoid valve is cut off, or when the engine clutch control solenoid valve itself fails, the internal passage of the valve control pressure maintains its initial blocked state. Consequently, the supply of hydraulic fluid to the engine clutch 12 is cut off and the engine clutch always stays open.

As described above, the conventional art employs, as the solenoid valve 62a controlling the engine clutch 12, a normal low type solenoid valve which maintains a low pressure state of hydraulic fluid supplied to the engine clutch (hereinafter, called “engine clutch supply pressure”) in the event of a failure of the engine clutch controller (cut-off of power to the valve) or a failure of the valve itself. At this time, since the valve is turned off and the fluid pressure is not supplied to the engine clutch, the engine clutch 12 is in an open state and thus it is impossible to connect the engine's rotational power so as to drive the vehicle in an emergency.

In the event that the power to the engine clutch control solenoid valve is cut off due to an engine clutch controller failure, or the engine clutch control solenoid valve itself undergoes a failure, it is necessary to drive the vehicle a service center to be fixed. However, even if the engine is turned on, since the engine clutch control solenoid is turned off, and thus the engine clutch is turned off, it is impossible to drive the vehicle in a limp home mode by the rotational power of the engine.

The information disclosed in this Background section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to solve the above problems, and an object of the present invention is to provide a limp home drive method for effecting limp home mode driving by drive power of an engine in the event of engine clutch controller failure or engine clutch control solenoid valve failure in a hybrid electric vehicle, and an engine clutch control hydraulic system for implementing the limp home driving.

In one aspect, the present invention provides an engine clutch control hydraulic system including: a hydraulic circuit for supplying hydraulic fluid to an engine clutch mounted between an engine and a driving motor; an engine clutch control solenoid valve installed along the hydraulic circuit for controlling supply of hydraulic fluid to the engine clutch; and an engine clutch controller for controlling operation of the engine clutch by controlling the engine clutch control solenoid valve according to vehicle driving conditions, wherein the engine clutch control solenoid valve is a normal high type solenoid valve that keeps open an internal passage through which the hydraulic fluid is supplied to the engine clutch so that the engine clutch control pressure is the maximum pressure when power is cut off.

Preferably, the normal high type solenoid valve has a structure in which the internal passage through which the hydraulic fluid is supplied to the engine clutch is always kept open, a valve control pressure generated by the valve control hydraulic fluid acts on a spool, and simultaneously the internal passage through which the hydraulic fluid is supplied to the engine clutch is always kept open by the operation of the spool.

In another aspect, the present invention provides a method for effecting limp home driving in the event of engine clutch controller failure in a hybrid electric vehicle equipped with an engine clutch control hydraulic system including a hydraulic circuit for supplying hydraulic fluid to an engine clutch mounted between an engine and a driving motor, an engine clutch control solenoid valve installed along the hydraulic circuit for controlling supply of hydraulic fluid to the engine clutch, and an engine clutch controller for controlling operation of the engine clutch by controlling the engine clutch control solenoid valve according to vehicle driving conditions, the method including the steps of: installing, as the engine clutch control solenoid valve, a normal high type solenoid valve that keeps an internal passage through which hydraulic fluid is supplied to the engine clutch open so that the engine clutch control pressure is the maximum pressure when power is cut off; supplying hydraulic fluid to the engine clutch through the internal passage so that the engine clutch closes and the engine is connected to the driving motor, when power to the engine clutch control solenoid valve is cut off due to a failure; and starting the engine to effect vehicle limp home driving by the drive power of the engine.

It is understood that the term “vehicle”, “vehicular” and other similar terms used herein are inclusive of motor vehicles in general, such as passenger automobiles including sports utility vehicles (SUV), buses, trucks, various commercial vehicles, watercraft including a variety of boats and ships, aircraft, and the like. The present systems and methods will be particularly useful with a wide variety of motor vehicles.

Other aspects of the invention are discussed infra.

### BRIEF DESCRIPTION OF THE DRAWINGS

FIG. 1 is a schematic diagram showing the structure of a power train in a conventional hybrid electric vehicle equipped with an engine clutch;

FIG. 2 is a hydraulic circuit diagram showing a conventional engine clutch control hydraulic system in a hybrid electric vehicle; and

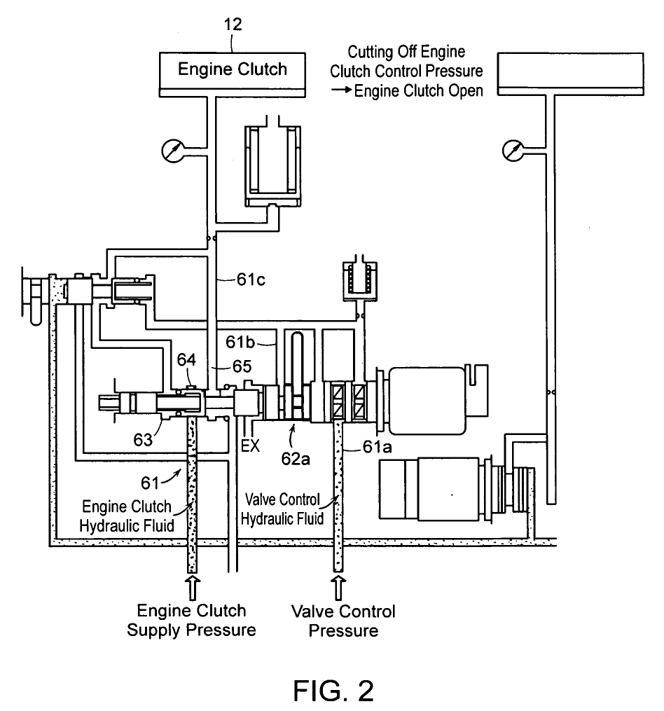

FIG. 3 is a hydraulic circuit diagram showing an engine clutch control hydraulic system in a hybrid electric vehicle in accordance with a preferred embodiment of the present invention.

Reference numerals set forth in the Drawings includes reference to the following elements as further discussed below:

| | |
|---|---|
| 10: engine | 11: torsion damper |
| 12: engine clutch | 20: driving motor |
| 30: automatic transmission | 40: ISG |
| 50: drive shaft | 51: drive wheel |
| 61: hydraulic circuit | 61a, 61b and 61c: hydraulic lines |
| 62a: normal low type engine clutch | |
| control solenoid valve | |
| 62b: normal high type engine clutch | |
| control solenoid valve | |
| 63: spring | 64: spool |
| 65: internal passage | |

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

One of the purposes of the present invention is to enable limp home driving by drive power of an engine in the event of engine clutch controller failure or engine-clutch control solenoid valve failure in a hybrid electric vehicle with an engine clutch mounted between the engine and a driving motor. Thus, the present invention provides an engine clutch control hydraulic system using a normal high (NH) type solenoid valve instead of a conventional normal low type solenoid valve as an engine clutch control solenoid valve, and a limp home driving method employing the engine clutch control hydraulic system.

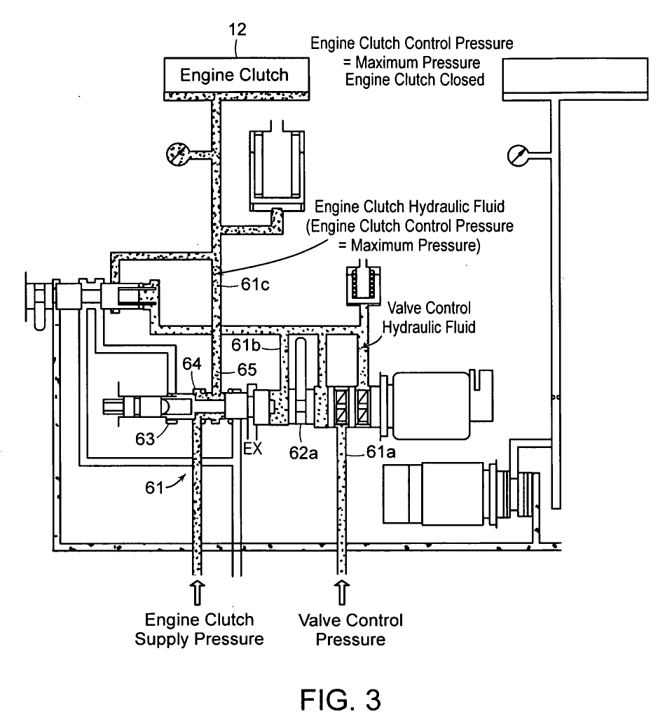

FIG. 3 is a hydraulic circuit diagram showing an engine clutch control hydraulic system of a hybrid electric vehicle according to a preferred embodiment of the present invention. It shows the initial working pressure state of the engine clutch control solenoid valve when valve power is off.

As shown in the figure, the engine clutch control hydraulic system includes a hydraulic circuit 61 for supplying hydraulic fluid to an engine clutch 12, and a solenoid valve 62b installed at the hydraulic circuit and controlling the operation of the engine clutch 12 by controlling the supply of hydraulic fluid to the engine clutch 12.

Conventionally, when the power is shut off due to a failure of an engine clutch controller or a valve itself, a normal low type solenoid valve is used which is designed to maintain a blocked state of the pressure of hydraulic fluid supplied to the engine clutch 12 (engine clutch supply pressure). In this case, the engine clutch 12 is kept open in the event of a failure, thus rendering the limp home driving by the drive power of the engine impossible.

In contrast, in the present invention, when the valve power is shut off due to a failure, a normal high type solenoid valve is used which maintains maximum control pressure of the engine clutch 12, i.e., maximum engine clutch supply pressure (engine clutch control pressure).

In the normal high type solenoid valve, in the event of a failure of the engine clutch controller or the valve itself, in a power-off state, an internal passage 65 is always kept open so that hydraulic fluid for controlling the valve (hereinafter, valve control hydraulic fluid) can flow therethrough. At the same time, the valve control pressure of the valve control hydraulic fluid is acted on an internal spool 64, and the internal passage 65 is kept open so that hydraulic fluid supplied to the engine clutch 12 can pass therethrough.

When the normal high type solenoid valve is used, since the internal passage 65 though which hydraulic fluid of the engine clutch 12 passes is always kept open in the event of a failure or cut-off of power, the engine clutch supply pressure, i.e., the engine clutch control pressure, is maintained at its maximum.

In this way, the present invention employs a normal high type engine clutch control solenoid valve 62b so that the control pressure of the engine clutch 12 is always at its maximum in the event of a failure of the engine clutch controller (HCU or TCU) or the valve itself.

Of course, when the engine clutch controller and the engine control solenoid valve 62b are in a normal state, the valve control hydraulic fluid passage is controlled in response to a control signal (electric signal) of the engine clutch controller, just as in the conventional art. Accordingly, the engine clutch hydraulic fluid, the engine clutch control pressure, and the operation of the engine clutch are all controlled normally.

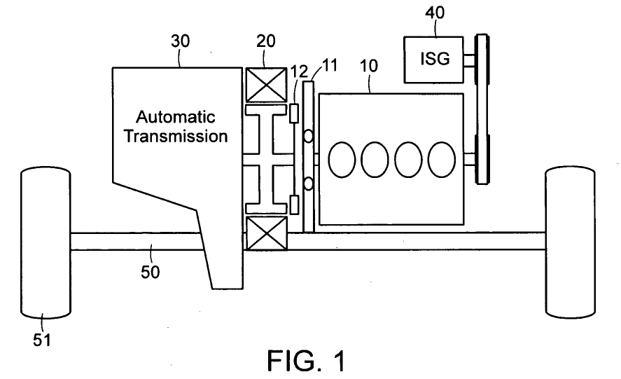

In this manner, the engine clutch control hydraulic system of the present invention employs a normal high type engine clutch control solenoid valve 62b that always keeps the control pressure of the engine clutch 12 at its maximum when the valve power is off. Thus, even when the valve power goes off due to a failure of the engine clutch controller or the engine clutch control solenoid valve, the control pressure of the engine clutch 12 is kept at its maximum level and the engine clutch 12 is kept closed. And, when the engine clutch 12 is closed, the engine (reference numeral 10 of FIG. 1) is connected with the driving motor (reference numeral 20 of FIG. 1).

Here, in the engine clutch control solenoid valve 62b, when the internal passage 65 for the valve control hydraulic fluid is open, the spool 64 inside the valve completely opens the internal passage 65 for engine clutch hydraulic fluid in response to the valve control hydraulic fluid. Thus, the maximum control pressure is applied to the engine clutch 12 and, consequently, the engine clutch 12 is closed by the maximum control pressure.

When the engine clutch 12 is closed, the engine 10 is connected directly to the vehicle's drive system, and the drive power of the engine can be transferred to the vehicle's drive shaft 50 through the driving motor 20. Under the combined control of an engine control unit (ECU) and a motor control unit (MCU), the engine 10 is started using the ISG 40, and the drive power of the engine is transferred to the driving motor 20 and the drive shaft 50 through the engine clutch 12 so that the vehicle's limp home mode can be executed under the transferred drive power of the engine.

As described above, the engine clutch control solenoid valve in a hybrid electric vehicle is implemented using a normal high type solenoid valve that ensures the engine clutch control pressure at its highest when the power is cut off. Thus, in the event of a failure of the engine clutch controller or the valve itself, even though the power is cut off, the engine clutch is kept closed by the hydraulic fluid supplied through the valve. Accordingly, the vehicle limp home driving by the drive power of the engine can be accomplished by driving the engine

The invention has been described in detail with reference to a preferred embodiment thereof. However, it will be appreciated by those skilled in the art that changes may be made in the described embodiment without departing from the principles and spirit of the invention, the scope of which is defined by the appended claims and their equivalents.

What is claimed is:

1. An engine clutch control hydraulic system comprising:
a hydraulic circuit for supplying hydraulic fluid to an engine clutch mounted between an engine and a driving motor;
an engine clutch control solenoid valve installed along the hydraulic circuit for controlling supply of hydraulic fluid to the engine clutch; and
an engine clutch controller for controlling operation of the engine clutch by controlling the engine clutch control solenoid valve according to vehicle driving conditions,
wherein the engine clutch control solenoid valve is a normal high type solenoid valve that keeps open an internal passage through which the hydraulic fluid is supplied to the engine clutch so that the engine clutch control pressure is the maximum pressure when power is cut off.

2. The engine clutch control hydraulic system, wherein the normal high type solenoid valve has a structure in which the internal passage through which the hydraulic fluid is supplied to the engine clutch is always kept open, a valve control pressure generated by the valve control hydraulic fluid acts on a spool, and simultaneously the internal passage through which the hydraulic fluid is supplied to the engine clutch is always kept open by the operation of the spool.

3. A method for effecting limp home driving in the event of engine clutch controller failure in a hybrid electric vehicle equipped with an engine clutch control hydraulic system including a hydraulic circuit for supplying hydraulic fluid to an engine clutch mounted between an engine and a driving motor, an engine clutch control solenoid valve installed along the hydraulic circuit for controlling supply of hydraulic fluid to the engine clutch, and an engine clutch controller for controlling operation of the engine clutch by controlling the engine clutch control solenoid valve according to vehicle driving conditions, the method including the steps of:
installing, as the engine clutch control solenoid valve, a normal high type solenoid valve that keeps open an internal passage through which hydraulic fluid is supplied to the engine clutch so that the engine clutch control pressure is the maximum pressure when power is cut off;
supplying hydraulic fluid to the engine clutch through the internal passage so that the engine clutch closes and the engine is connected to the driving motor, when power to the engine clutch control solenoid valve is cut off due to a failure; and
starting the engine to effect vehicle limp home driving by the drive power of the engine.
